(19) United States
(12) Patent Application Publication
(10) Pub. No.: US 2013/0036801 A1
(43) Pub. Date: Feb. 14, 2013

(54) APPARATUS AND METHOD FOR MEASURING MOMENT OF INERTIA

(71) Applicants: Bryan Bingham, Providence, UT (US); Michael S. Watson, North Logan, UT (US); Steven R. Wassom, Smithfield, UT (US)

(72) Inventors: Bryan Bingham, Providence, UT (US); Michael S. Watson, North Logan, UT (US); Steven R. Wassom, Smithfield, UT (US)

(73) Assignee: Utah State University Research Foundation, North Logan, UT (US)

(21) Appl. No.: 13/357,336

(22) Filed: Jan. 24, 2012

Related U.S. Application Data
(60) Provisional application No. 61/521,249, filed on Aug. 8, 2011.

(51) Int. Cl. G01M 1/00

(52) U.S. Cl. 73/65.08

(57) ABSTRACT

A method and apparatus for determining the mass moment of inertia of a given object is disclosed, The apparatus is a mass moment of inertia platform whereon objects to be measured can be placed. The platform uses flex pivots as torsional springs and the method ensures the flex pivots are procured and assembled in such a way so as to limit flex pivot misalignment systemic errors thereby resulting in a highly accurate and low-cost apparatus for measuring the mass moment of inertia.

### RELATED APPLICATIONS

This patent claims the benefit of U.S. Provisional Application 61/521,249 filed Aug. 8, 2011 and entitled APPARATUS AND METHOD FOR MEASURING MOMENT OF INERTIA, which is hereby incorporated herein by reference.

### FIELD OF THE INVENTION

This disclosure relates to an apparatus and method for measuring the moment of inertia of an object, and more particularly, to a platform for measuring the oscillation frequency around a given axis for a given object.

### BACKGROUND OF THE INVENTION

The mass moment of inertia is an object's natural resistance to a twisting force or torque. It is a very critical parameter in the operation of satellites and other dynamic systems, since internal parts which may occasionally move might cause a torque on the entire object resulting in undesired rotation. Traditionally, the mass moment of inertia of an object has been measured by suspending the object from a wire and rotating the object in a configuration referred to as a filar pendulum. This application and accuracy of the filar pendulum design is sufficient for small objects which can be easily suspended by a single wire and which do not require accurate measurements.

There are multiple arrangements of filar pendulums and other moment of inertia apparatuses which primarily suspend the object to be measured. Suspending larger or very expensive objects can be a risky activity.

There are some recent innovations regarding apparatuses which claim to measure the moment of inertia without the need for suspension. Some known devices use air bearing technology and torsion rods. These systems are complex and expensive. These innovations overcome the deficiencies of suspension design; however, they are not practical for those with limited financial resources. Other inertia-measuring apparatuses use a combination of torsional springs and mechanical bearings; however, the bearings produce unwanted sliding friction which reduces the accuracy of the measurement.

The accuracy of the suspension design is insufficient for previously mentioned satellites and other dynamic systems because the twisting motion of the suspending material inevitably causes a translation to occur. A translation in the object being measured has negative effects on the accuracy of the measurements of mass moment of inertia.

The accuracy limitations of the suspension designs combined with the high cost of the air bearing and torsion rod designs leaves a need in the market for a low-cost apparatus for accurately measuring the mass moment of inertia for an object. This need is addressed in the present disclosure.

### SUMMARY OF THE INVENTION

The mass moment of inertia of an object can be measured by rotating the object with a torsional pendulum and measuring the period at which the object oscillates. Many test fixtures have been created in the past to accomplish this, ranging from simply suspending the object by a wire or other methods, to much more complicated and expensive air bearing and torsion rod designs. The disclosed torsional pendulum can be used to measure the mass moment of inertia of an object placed upon it. The use of flexural pivots (also known as flex pivots) supporting a platform where objects can be placed allows for a simple, compact torsional pendulum which overcomes the limitations of suspending objects, is much more accurate than suspension designs, and maintains many of the advantages of the more expensive test fixtures. A flex pivot is a unique device which has a low torsional spring rate to allow rotation in a single degree of freedom about a preferential axis, while providing high translational and rotational stiffness in all other degrees of freedom. A flex pivot has no sliding friction and only negligible amounts of internal friction, which greatly improves the accuracy of the measurement.

The disclosed invention specifies the use of flex pivots as the required torsional springs in a device used for measuring the mass moment of inertia. “Flex pivot,” as used in this application, refers to a single-ended cantilevered pivot bearing and describes two coaxial collars connected by internal beams such that the collars can rotate relative to one another through the bending of the internal beams. Flex pivots provide both the necessary torsional restoring force in one rotational direction and the necessary stiffness to limit translation and rotation of the moving body in all other directions, thus enabling an accurate measurement of the mass moment of inertia. Using flex pivots in this manner is very accurate and overcomes the many limitations of the traditional filar pendulum design or the mechanical bearing design; however, they do not approach the cost of air bearing and torsion rod designs which are cost prohibitive for many smaller projects.

### BRIEF DESCRIPTION OF THE DRAWINGS

Understanding that drawings depict only certain preferred embodiments of the invention and are therefore not to be considered limiting of its scope, the preferred. embodiments will be described and explained with additional specificity and detail through the use of the accompanying drawings in which:

FIG. 1 illustrates one embodiment of the complete assembly.

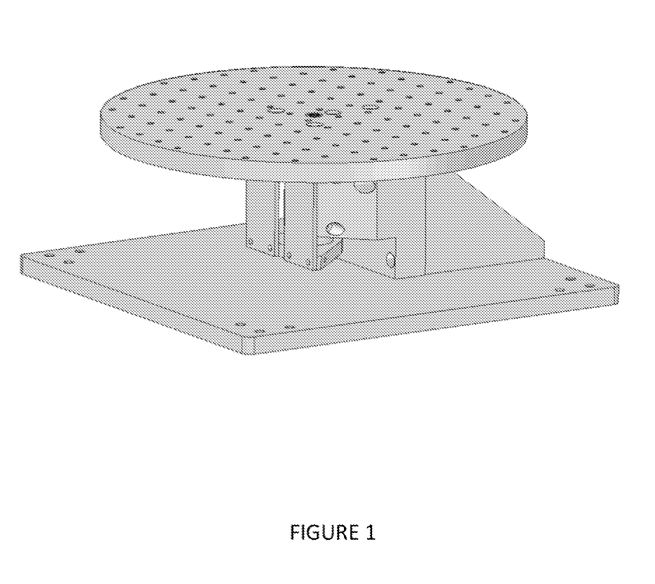

FIG. 2 illustrates an exploded view of an embodiment with the key parts labeled.

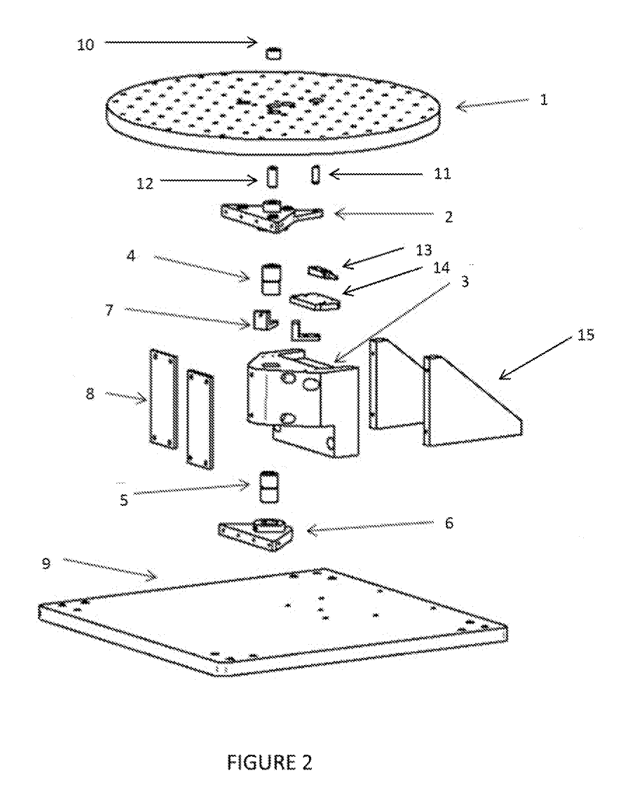

### DETAILED DESCRIPTION OF SELECTED EMBODIMENTS

In the following description, numerous specific details are provided for a thorough. understanding of specific preferred embodiments. However, those skilled in the art will recognize that embodiments can be practiced without one or more of the specific details, or with other methods, components, materials, etc. In some cases, well-known structures, materials, or operations are not shown or described in detail in order to avoid obscuring aspects of the preferred embodiments. Furthermore, the described features, structures, or characteristics may be combined in any suitable manner in a variety of alternative embodiments. Thus, the following more detailed description of the embodiments of the present invention, as represented in the drawings, is not intended to limit the scope of the invention, but is merely representative of the various embodiments of the invention. Disclosed herein is a mass moment of inertia table using flex pivots as a torsional spring.

Two flex pivots 4, 5 are attached to each other using mechanical clamps 2, and 6, spacers 8, and support structure 3. The mechanical clamp utilized in this embodiment of the assembly is a screw clamp design where tightening a screw position tangentially to the flex pivot generates a clamping force around the outside diameter of the pivot. In other embodiments other clamping designs would be, for example, to use a setscrew radially against the outer diameter of the flex pivot, or to use an alignment pin or square key tangentially to the flex pivot. A table or platform 1, or functionally similar shape, is constructed and aligned directly on top of the vertical axis comprised of the flex pivots 4, 5, clamps 2 and 6, spacers 8, and support structure 3 such that the platform 1 oscillates back and forth, relative to the support structure 3, when a rotational offset is applied. The platform 1 is bolted to the topside of the mechanical clamp 2 using bolt fasteners. Likewise, the spacers 8 are fastened to the mechanical clamps 2 and 6 using bolt fasteners. The platform 1 is mechanically limited in rotation by clamp 2 contacting rigid stops 7, such that an identical offset can be applied by artificially rotating the top surface to its mechanical limits, The rigid stops 7 are mechanically attached to support structure 3 using bolt fasteners. In another embodiment the invention can also include an inductive non-contact sensor 13 and 14 which can determine the oscillation frequency of the platform by sending a signal to a computer or other device each time a defined point of the platform passes the sensor. The platform 1 is aligned to the top mechanical clamp 2 using two stainless steel alignment pins 11 and 12 and a sleeve bushing 10. In one embodiment all components are manufactured from 6061-T6 aluminum with the exception of 10,11,12 which are stainless steel and 4,5 which are AIS 420 corrosion-resistant steel. Other embodiments may include alternative materials.

in one embodiment the apparatus is supported using a central support structure 3 and reinforcing gussets 15 mounted on abuse 9 using bolt fasteners. The rotational elements 1, 4, and 5 are aligned along the axis of rotation using this supporting structure 3.

An alternative method of measurement involves using a high-speed video camera with time stamp capability to capture the motion of a fiduciary mark on the rotating portion of the platform 1. The time data from the time stamps on each frame is then used to determine the oscillation frequency.

In embodiments there is disclosed herein a torsional pendulum. The frequency of the rotational oscillation (ω) of a torsional pendulum is a known function of its torsional spring rate (K) and mass moment of inertia J such that ω=√(K/J).

The torsional spring rate of the disclosed invention is the torsional spring rate of the flex pivots used in its construction, and is given by suppliers or can be measured. The mass moment of inertia of the pendulum is known from the models used in its manufacture or can be calculated by measuring the oscillation frequency of the pendulum as described above using:

J_{pendulum}=K/ω_{pendulum}².

The mass moment of inertia of an object is measured by first placing the object on the platform 1 Then the axis of the object about which the mass moment of inertia is to be measured is oriented so that it is collinear with the flex pivots. A rotational oscillation is induced and the frequency of this oscillation is measured. The mass moment of inertia of the object is calculated using knowledge of the torsional pendulum upon which it was placed using:

J_{object}=K/ω²−J_{pendulum}.

i) Any given spatial axis can be measured by an appropriate placement of the object to be measured on the platform II, Alternate surface types can also be used instead of a flat platform 1. For example, one skilled in the art can craft other surface types which can be easily axially rotated so as to measure other spatial axes of the object being analyzed.

In embodiments of this system flex pivots are used as the rotational elements; however, the proper selection, placement and alignment of the flex pivots is also required in order to attain the necessary accuracy. Commercially available flex pivots of appropriate torsional stiffness and axial load capacity may be selected. Flex pivot installation may be conducted per the manufacturer's recommended practice. Coalignment of the flex pivot's rotational axis will minimize systematic errors in inertial measurements. This coaligment can be achieved in multiple methods.

One method of coalignment is to build the flex pivot mounting and clamping parts with sufficiently high precision. Sophisticated machining practices, such as electrical discharge machining, can produce flex pivot seating surfaces for both flex pivots simultaneously while maintaining very small tolerances. In this manner, the initial installation of flex pivots will result in a well aligned system.

Alternately, or in addition, the flex pivots can be shimmed into alignment using an optical device and reticle to determine flexes pivot concentricity. In this manner, less expensive mounting and clamping parts of more coarse tolerances could be utilized. Aligning the reticle with the flex pivot cross beams will give an indication of direction and magnitude of the required shims. Analyzing the data from these various measurements allows an individual to fully understand the system's dynamic output and construct a highly accurate mass moment of inertia apparatus which can be used for a wide variety of objects and configurations.

This ultimately provides significant advantages over the traditional filar pendulum designs, and approaches the accuracy of the expensive air bearing and torsion rod designs.

The above description discloses the invention including preferred embodiments thereof. The examples and embodiments disclosed herein are to be construed as merely illustrative and not a limitation of the scope of the present invention in any way. It will be obvious to those having skill in the art that many changes may be made to the details of the above-described embodiments without departing from the underlying principles of the invention.

1. An inertial moment measuring apparatus comprising:
two flex pivots;
a platform;
said flex pivots coaxially aligned and attached to each other;
said platform mounted perpendicular to the axis of said Ilex pivots;
wherein said platform has rotational motion about said axis of said flex pivots;
wherein said platform oscillates about said axis of said flex pivots when a rotational offset is applied; and
a mechanical stop wherein said mechanical stop limits rotation of said platform.

2. The apparatus of claim I wherein said flex pivots are attached using a mechanical clamp.

3. The apparatus of claim I further comprising:
a sensor that can determine the oscillation frequency of the platform.

4. The apparatus of claim 3 wherein said sensor sends a signal to a computer or other device each time a defined point of the platform passes the sensor.

5. The apparatus of claim I further comprising:
a video camera with time stamp capability;
said video camera configured to capture the motion of a fiduciary mark on the rotating portion of the platform.

6. The apparatus of claim 5 wherein the time data from said time stamps on each frame is the used to determine the oscillation frequency.

7. The apparatus of claim 6 wherein said oscillation frequency is used to calculate the moment of inertia of said apparatus and any object placed thereon.

8. The apparatus of claim 1 wherein said platform has a flat surface.

9. The apparatus of claim 1 wherein said platform has a surface conformed to an object of interest.

10. A method for measuring moment of inertia of an object comprising:
coaxially aligning two flex pivots;
mounting a platform onto said flex pivots;
wherein said platform has rotational movement about said axis of said flex pivots;
wherein said platform oscillates about said axis of said flex pivots when a rotational offset is applied;
placing said object on said platform such that axis of said object about which the mass moment of inertia, is to be measured is oriented so that it is collinear with the axis of said flex pivots;
applying a rotational offset to said platform;
measuring the oscillation frequency of said platform while holding said object; and
computing the moment of inertia of the object from said oscillation frequency.

11. The method of claim 10 wherein:
measuring the oscillation frequency of said platform while holding said object utilizes a sensor that can determine the oscillation frequency of the platform.

12. The method of claim 11 wherein said sensor sends a signal to a computer or other device each time a defined point of the platform passes the sensor.

13. The method of claim 10 wherein:
measuring the oscillation frequency of said platform while holding said object utilizes high-speed video camera with time stamp capability;
said camera configured to capture the motion of a fiduciary mark on the rotating portion of the platform.

14. The method of claim 13 wherein the time data from said time stamps on each frame is then used to determine the oscillation frequency.

15. The method of claim 10 wherein said oscillation frequency is used to calculate the mass moment of inertia of said flex pivots, platform and other supporting rotating parts without said object, J_{pendulum}, using the formula J_{pendulum}=K/ω_{pendulum}²;
wherein K is the torsional spring rate of said flex pivots, platform and other supporting rotating parts without said object; and
wherein ω_{pendulum} is the frequency of the rotational oscillation without said object.

16. The method of claim 15 wherein said oscillation frequency is used to calculate the mass moment of inertia of said object, J_{object}, using the formula J_{object}=K/ω²−J_{pendulum} wherein ω is the frequency of the rotational oscillation of said flex pivots, platform and other supporting rotating parts with said object.

17. The method of claim 10 wherein multiple mass moments of inertia are calculated for said object by performing multiple measurements wherein said object is placed on said platform such that axis of said object about which each the mass moment of inertia, is to be measured is oriented so that it is collinear with the axis of said flex pivots.

18. The method of claim 10 wherein a mechanical stop limits rotation of said platform.

19. The method of claim 10 wherein said platform is mounted perpendicular to the axis of said flex pivots
